(19) United States
(12) Patent Application Publication
(10) Pub. No.: US 2005/0213662 A1
(43) Pub. Date: Sep. 29, 2005

(54) Method of compression and digital imaging device employing compression algorithm

(76) Inventors: James Owens, Fort Collins, CO (US); Andrew C. Goris, Loveland, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/811,739

(22) Filed: Mar. 29, 2004

(51) Int. Cl. H04N 7/12

(52) U.S. Cl. 375/240.16; 375/240.12; 375/240.01

(57) ABSTRACT

In one embodiment, a digital imaging device comprises an imaging subsystem for capturing video frames, a motion sensor for detecting movement of the device, and encoding logic for encoding video frames from the imaging subsystem according to a motion compensation compression algorithm, wherein the encoding logic determines motion vectors by displacing interframe search areas using information from the motion sensor.

### DESCRIPTION OF RELATED ART

Video compression algorithms typically employ a variety of mechanisms, such as exploitation of intraframe redundancy, to efficiently encode video frames. Intraframe redundancy refers to the correlation between spatially adjacent pixels within a single video frame. To take advantage of intraframe redundancy, some known compression algorithms divide a single video frame of image data into a plurality of blocks and perform an appropriate mathematical transform (e.g., the Discrete Cosine Transform (DCT)) on each block. Quantization is then performed to limit the dynamic range of the image data in the transform domain. After quantization, a large number of frequency coefficients will generally be repeated within and among the blocks. The transformed and quantized image data can then be encoded relatively efficiently using run-length encoding, end-of-block codes, and a variable length encoding scheme (e.g., Huffman coding).

Video compression algorithms also typically exploit interframe redundancy. Interframe redundancy refers to the temporal correlation between corresponding pixel elements associated with multiple frames. For example, if video data is sampled at a rate of 30 Hz or higher, the amount of change in the image data between successive frames can be relatively low. In video compression algorithms, a difference or error signal can be generated that is indicative of the difference between two or more frames. For many frames, a significant portion of the difference signal will be represented by “zeros,” thereby indicating that there is no difference between the corresponding pixel elements of the frames. In a manner similar to intraframe coding, run-length encoding, end-of-block codes, and a variable length encoding scheme can be used to efficiently code the difference signal.

When a direct pixel-by-pixel comparison is performed to generate the difference signal, movement of objects within the video data between successive frames reduces the amount of redundancy in the difference signal. “Motion compensation” refers to algorithmic techniques used to maintain redundancy in the difference signal despite movement of objects between frames.

For example, the Moving Picture Expert Group (MPEG) video compression standards perform motion compensation by separating each frame into non-overlapping “blocks” or “macroblocks” of pixels. A macroblock (MB) is a 2×2 matrix of blocks. A motion vector is determined for each block or MB. The motion vector for a particular block or MB defines the pixels from which the portion of the difference signal related to the particular block or MB was generated. For example, suppose that an object moves “down” by a number of pixels between a first frame and a second frame. For the multiple blocks containing the object, motion vectors are determined that encode the amount of pixel movement. The difference signal between the first and second frames is then minimized by comparing the pixels of the blocks of that object in the second frame to pixels of the first frame that are relatively shifted “up” by the determined motion vectors.

### SUMMARY

In one embodiment, a digital imaging device comprises an imaging subsystem for capturing video frames, a motion sensor for detecting movement of the device, and encoding logic for encoding video frames from the imaging subsystem according to a motion compensation compression algorithm, wherein the encoding logic determines motion vectors by displacing interframe search areas using information from the motion sensor.

In another embodiment, a method of compressing video images used in association with an image capture device comprises receiving at least first and second video frames, receiving motion information related to a movement of the device from at least one motion sensor, selecting a reference block of pixels within the second frame, selecting a search area within the first frame, wherein the search area is displaced from a position defined by the selected reference block using the motion information, and determining an interframe motion vector by comparing the reference block of pixels within the second frame to pixels within the search area of the first frame.

In another embodiment, a system comprises means for generating video images, means for detecting motion of the system, and means for encoding the video images according to a motion compensation compression algorithm, wherein the means for encoding displaces search areas during motion vector calculation in response to information received from the means for detecting.

### BRIEF DESCRIPTION OF THE DRAWINGS

FIGS. 1A and 1B depict frames to be encoded according to a motion compensation compression algorithm.

FIGS. 2A and 2B depict frames to be encoded according to a motion compensation compression algorithm according to one representative embodiment.

FIG. 3 depicts a flowchart for processing video data according to one representative embodiment.

FIG. 4 depicts a video device according to one representative embodiment.

FIG. 5 depicts another video device according to one representative embodiment.

FIG. 6 depicts a flowchart according to one representative embodiment.

FIG. 7 depicts another flowchart according to one representative embodiments.

### DETAILED DESCRIPTION

During the encoding of a series of video frames according to a motion compensation compression algorithm, digital video devices typically encode “intracoded” frames from time to time. Intracoded frames are frames that can be subsequently decoded without reference to other frames. Essentially, intracoded frames are stand-alone still images. Between the intracoded frames, “interceded” frames (referred to as “predicted” and “bidirectional” frames according to the MPEG standard) are encoded. Intercoded frames are subsequently decoded or reconstructed from one or several intracoded and/or other interceded frames, one or several difference signals, and the associated motion vectors.

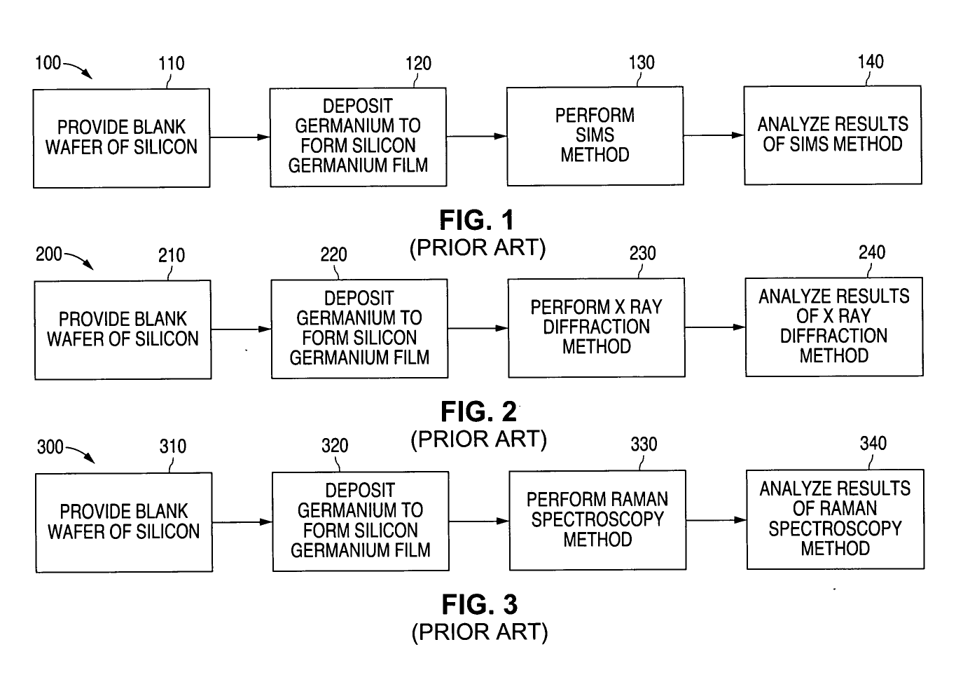

Referring now to the drawings, FIG. 1A depicts frame 100 to be encoded as an intercoded frame. Frame 150 of FIG. 1B is an intracoded frame from which frame 100 can be reconstructed using motion vectors and difference information. Frames 100 and 150 are assumed to be frames of 512×512 pixels for the purposes of discussion. During the encoding process, frame 100 may be divided into a plurality of “macroblocks.” For the sake of clarity, only macroblock 101 is shown in FIG. 1A.

Macroblock 101 is shown as having a height of sixteen pixels and a width of sixteen pixels. Also, the upper left pixel of macroblock 101 is located at pixel location (256, 256) and the lower right pixel of macroblock 101 is located at pixel location (271, 271). To determine the motion vector associated with macroblock 101, it is assumed that an object could move sixteen pixels “up” or “down” between frames and could also move sixteen pixels “left” or “right” between frames. Search area 151 is defined using this assumption. Specifically, the upper left pixel of search area 151 is located at pixel location (240, 240) and the lower right pixel is located at pixel location (287, 287).

To determine the motion vector for macroblock 101, a comparison is made between macroblock 101 and each possible group of contiguous 16×16 pixels within search area 151. A sum of differences error metric may be employed for the comparison. For example, the sum of differences between macroblock 101 and group 152 (which is located at pixel location (269, 245)) is given by:

$${\sum }_{x = 0}^{15} {\sum }_{y = 0}^{15} f ( 256 + x , 256 + y ) - {f}^{′} ( 269 + x , 245 + y ) , \qquad ( Equation 1 )$$

where f( ) represents a pixel value in frame 100 and f′( ) represents a pixel value in frame 150.

The group of pixels that exhibits the lowest error metric is used to define the motion vector. Assuming that group 152 exhibits the lowest error metric, the motion vector is given by (−13,11). Macroblock 101 is then encoded using the motion vector (−13, 11) and the difference signal D(x,y) given by D(x,y)=f(256+x, 256+y)−f′(269+x, 245+y), where x,y=0,1,2 . . . 15.

Because of the assumption that an object can move 16 pixels along each axis, search area 151 is relatively large. Specifically, to determine a single motion vector using search area 151, 1024 macroblock comparisons as shown above in Equation 1 are made. Furthermore, determining a motion vector for each macroblock in frame 100 of size 512×512 pixels requires 1,048,576 macroblock comparisons. Thus, the determination of the motion vectors according to a motion compensation compression algorithm is quite computationally intensive. The assumption regarding the possible movement of an object between frames can be restricted to limit the search area and thereby reduce the number of computations. However, indiscriminately restricted assumptions regarding the movement of an object can prove incorrect too frequently and lead to reduced compression performance.

Some representative embodiments of the present invention enable video compression algorithms to employ a relatively small search area for block comparison without appreciably reducing the compression performance. By employing a motion sensor that detects the physical translation and/or changes in the orientation of the imaging device used to capture the video frames, the search area can be selectively displaced relative to the macroblocks for the comparison process. Because the displacement is related to the detected motion, the probability of identifying an optimal motion vector is increased even though a relatively small search area is employed.

FIGS. 2A and 2B depict displacement of the search area according to one representative embodiment. FIG. 2A depicts frame 200 to be interceded using frame 250. Frame 200 includes block 201 with its first pixel located at pixel location (X, Y). It is assumed that an object may move “W” pixels in the X-direction and “H” pixels in the Y-direction between frames. According to one embodiment, an estimated pixel displacement of (ΔX, ΔY) is calculated upon the basis of the information received from one or several motion sensors. The estimated pixel displacement is related to the change in the video frames that results from movement of the video device. If no movement of the video device occurred (ΔX=0 and ΔY=0), search area 251 in frame 250 would be selected with its first pixel being located at pixel location (X-W, Y-H). When movement is detected, search area 252 in frame 250 is selected that is offset by the estimated pixel displacement. Specifically, the first pixel of search area 252 is located at pixel location (X-W-ΔX, Y-H-ΔY).

FIG. 3 depicts a method for processing video data by a digital video device according to one representative embodiment. In step 301, a video frame is received and encoded according to intraframe techniques. In step 302, another video frame is received.

In step 303, motion information is obtained from a motion sensor of the digital video device that is indicative of the motion (e.g., translation and/or change in angular orientation) of the digital video device during the interim between the capture of the present video frame and the prior video frame. Various types of motion sensors may be employed according to representative embodiments. In one representative embodiment, a gyroscopic sensor may be used to provide information indicative of the angular rotation of the digital video device. Additionally or alternatively, microaccelerometers may be used to provide information indicative of physical translation along an axis within the plane defined by the imaging subsystem. Moreover, pairs of microaccelerometers may be suitably disposed to generate a difference signal that is indicative of rotation of the digital video device.

In step 304, the signals from the motion sensor are digitized and provided to suitable logic to generate a pixel motion estimate. Specifically, the logic calculates the “ΔX” and “ΔY” pixel displacement that results from the movement of the digital video device. The implementation of the logic depends upon the implementation of the imaging subsystem of the device and the motion sensor(s) selected for the device. For example, if sensors are selected that detect a change in the angular orientation of the device, a “small-angle” approximation can be employed. That is, because the sampling rate of the device is relatively high, the change in angular orientation between two successive frames can be assumed to be relatively low. Thus, the pixel translation can be estimated to be a suitable multiple of the detected change in angular orientation. Likewise, for sensors that detect lateral translation of a video device, the pixel translation can be estimated as a multiple of the detected change in physical position.

In step 305, a block from the video frame received in step 302 is selected to begin the motion vector determination portion of the compression algorithm. The first pixel of the block is located at position (X, Y). In step 306, a search area in the prior video frame is defined using the selected block and the estimated pixel translation. Specifically, the search area is displaced relative to the block selected in step 305 by the estimated pixel translation. For example, a relatively small search area may be selected for the compression algorithm (e.g., a search area that is 24×24 pixels). The first pixel of the search area in the prior video frame may be located at (X-4-ΔX, Y-4-ΔY).

In step 307, the motion vector is determined for the selected block using the defined search area according to a suitable block comparison scheme. Because the displacement of the search area is related to the detected motion of the device, the probability of determining an optimal motion vector is increased even though a relatively small search area is employed. Specifically, the change in the video frames that results from movement of the video device is addressed through the displacement of the search area.

In step 308, the difference signal is determined between the block and the respective pixels in the previous video frame as defined by the motion vector. In step 309, the block is encoded using the motion vector and the difference signal according to an appropriate motion compensation compression algorithm.

In step 310, a logical comparison is made to determine whether there are additional blocks to be encoded within the current video frame. If so, the process flow returns to step 305. If not, the process flow proceeds to step 311.

In step 311, a logical comparison is made to determine whether a predetermined number of interceded frames have been encoded. If not, the process flow proceeds to step 302 to continue intercoding of the video frames. If a predetermined number have been interceded, the process flow returns to step 301 to encode the next frame according to intraframe techniques. Specifically, interspersing intracoded frames in the video stream in a periodic manner is used to reduce the amount of coding noise associated with the compression algorithm.

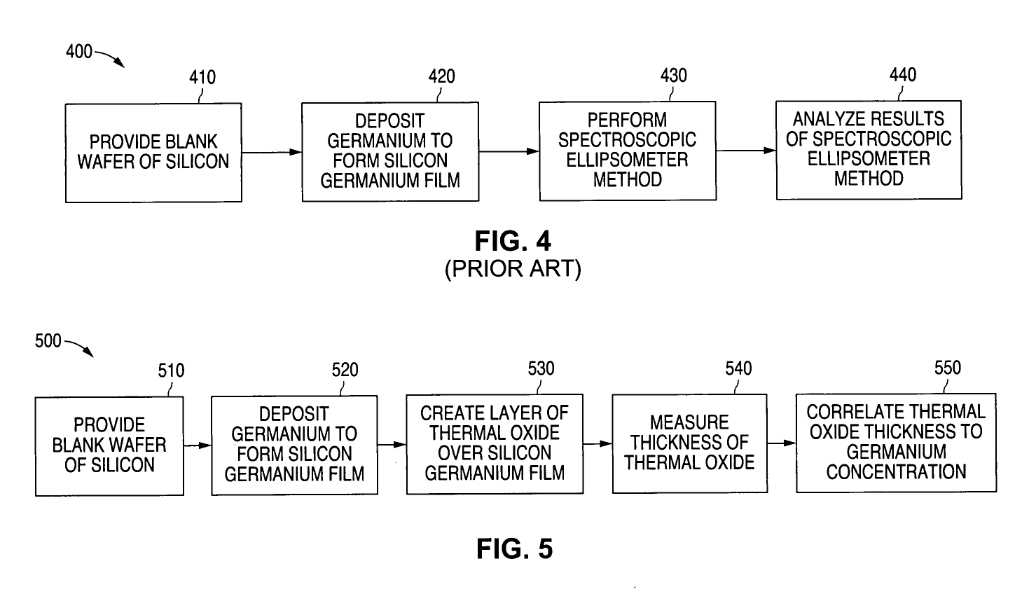

FIG. 4 depicts digital video device 400 according to one representative embodiment. Device 400 includes imaging subsystem 401 that may be implemented using known imaging circuitry (e.g., charge-coupled device (CCD) array, analog-to-digital converters, and/or the like). Imaging subsystem 401 generates the digital data of captured video frames and communicates that digital data for storage in memory 402. Device 400 also includes motion sensor(s) 405. Motion sensor(s) 405 may be implemented using a gyroscope, accelerometer(s), and/or the like.

Encoding logic 403 compresses the video frames according to a motion compensation compression algorithm according to representative embodiments. Specifically, in one embodiment, encoding logic 403 includes block comparison logic 404 that performs search area displacement using information from motion sensor(s) 405. Encoding logic 403 can be implemented using the flowchart shown in FIG. 3 as an example. Additionally, encoding logic 403 can be implemented using an application specific integrated circuit (ASIC) or using a processor and executable code. The executable code can be stored on any suitable computer readable medium such as read only memory (ROM). Because the computational nature of the compression algorithm is reduced, a lower complexity ASIC or processor may be used and, hence, the expense of device 400 can be reduced. The encoded video data may be stored in non-volatile memory 406 and/or provided to another device using video interface 407.

FIG. 5 depicts digital video device 500 according to one representative embodiment in which pairs of accelerometers 501 are employed. Accelerometers 501-1 and 501-2 are disposed on opposite ends of a single “wall” of device 500. Accelerometers 501-1 and 501-2 enable detection of translation of device 500 along an axis that is normal to the Cartesian plane containing these accelerometers. Additionally accelerometers 501-1 and 501-2 are coupled to adder 502-1. Adder 502-1 sums the signal from accelerometer 501-1 with the inverse of the signal from accelerometer 501-2 to generate a differential signal. The differential signal enables detection of a change in angular orientation. Likewise, accelerometers 501-3 and 501-4 are disposed on another wall of device 500. Accelerometers 501-3 and 501-4 are respectively coupled to adder 502-2 to generate another differential signal. A third set of accelerometers (not shown) could be similarly implemented to enable translation of device 500 and changes in the angular orientation of device 500 to be detected with respect to three axes.

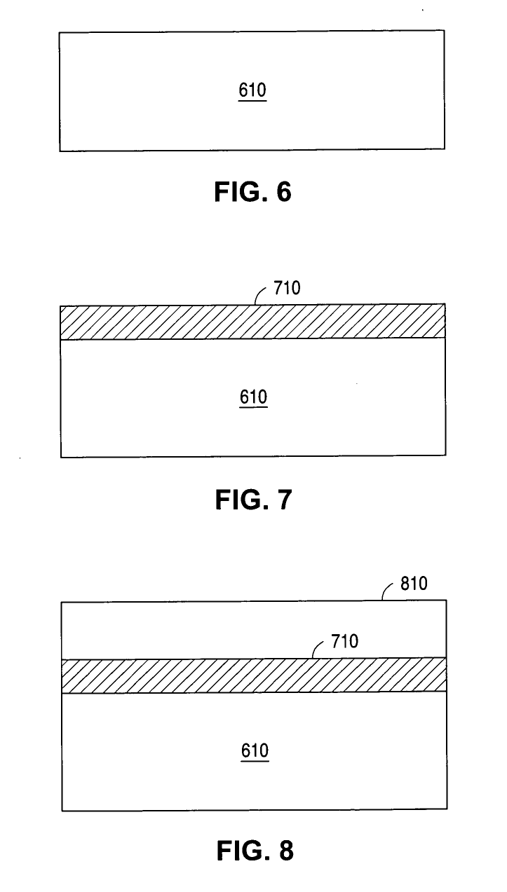

FIG. 6 depicts a flowchart according to one representative embodiment. In step 601, video images are generated by an imaging device. In step 602, motion of the imaging device is detected. In step 603, the video images are encoded according to a motion compensation compression algorithm, wherein the encoding displaces search areas during motion vector calculation in response to information received from the detecting.

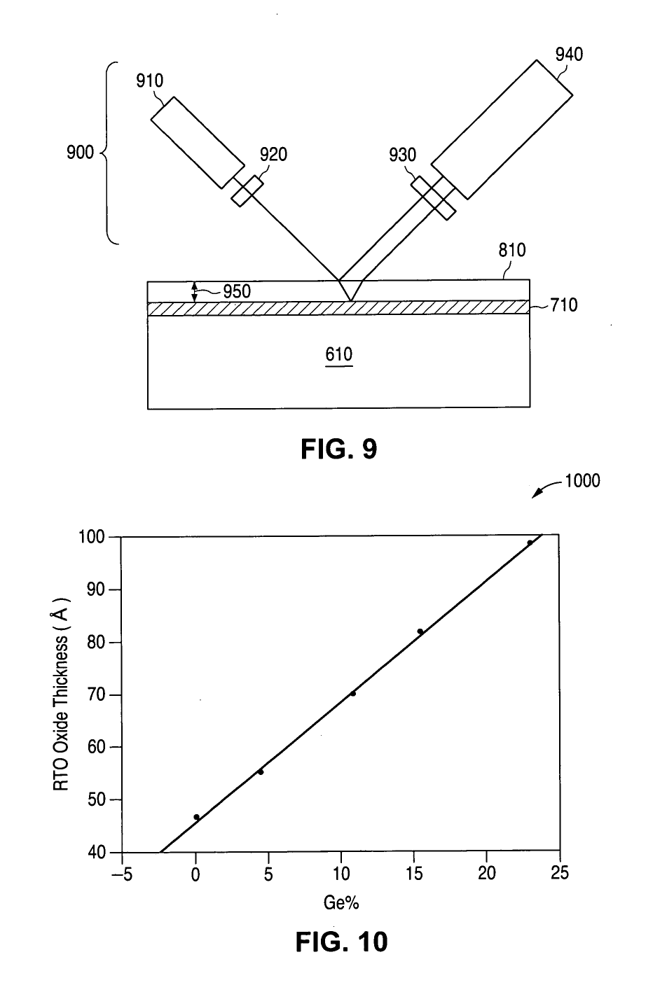

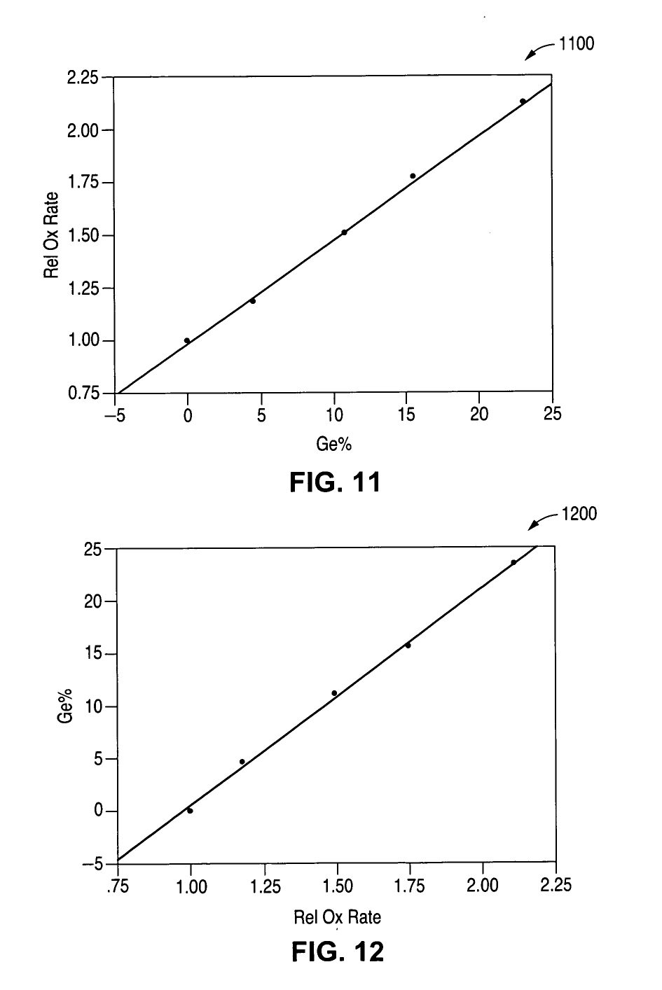

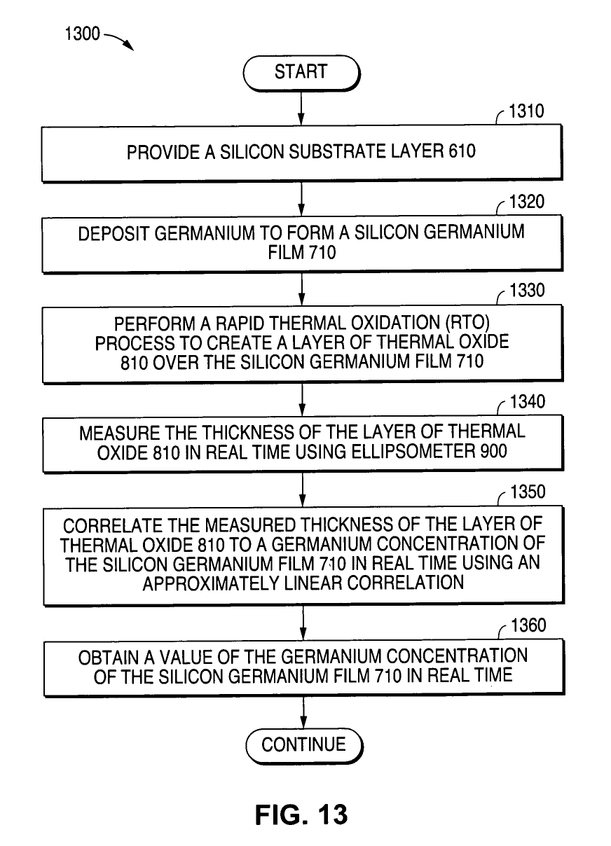

FIG. 7 depicts another flowchart for compressing video images used in association with an image capture device according to one representative embodiment. In step 701, at least first and second video frames are received. In step 702, motion information related to a movement of the device is received from at least one motion sensor. In step 703, a reference block of pixels is selected within the second frame. In step 704, a search area is selected within the first frame, wherein the search area is displaced from a position defined by the selected reference block using the motion information. In step 705, an interframe motion vector is determined by comparing the reference block of pixels within the second frame to pixels within the search area of the first frame.

Some representative embodiments enable motion compensation compression algorithms to be performed in an efficient manner. Specifically, a relatively small search area may be employed for block comparison, because the change between video frames that results from device movement is addressed through motion sensors and suitable logic. Furthermore, the complexity of video devices may be reduced by representative embodiments.

1. A digital imaging device comprising:
an imaging subsystem for capturing video frames;
a motion sensor for detecting movement of said device; and
encoding logic for encoding video frames from said imaging subsystem according to a motion compensation compression algorithm, wherein said encoding logic determines motion vectors by displacing interframe search areas using information from said motion sensor.

2. The device of claim 1 wherein said motion sensor generates information indicative of angular translation.

3. The device of claim 1 wherein said motion sensor generates information indicative of linear displacement.

4. The device of claim 1 wherein said encoding logic implements a function that calculates an estimated interframe pixel displacement using information generated by said motion sensor.

5. The device of claim 4 wherein said function is a linear function.

6. The device of claim 4 wherein said encoding logic is implemented within an application specific integrated circuit.

7. The device of claim 4 wherein said encoding logic is implemented using software instructions.

8. A method of compressing video images used in association with an image capture device, said method comprising:
receiving at least first and second video frames;
receiving motion information related to a movement of said device from at least one motion sensor;
selecting a reference block of pixels within said second frame;
selecting a search area within said first frame, wherein said search area is displaced from a position defined by said selected reference block using said motion information; and
determining an interframe motion vector by comparing said reference block of pixels within said second frame to pixels within said search area of said first frame.

9. The method of claim 8 further comprising:
determining a displacement vector from said motion information and originating at a position in said first frame associated with said reference block's position in said second frame, wherein said selecting said search area employs said displacement vector to locate said search area.

10. The method of claim 8 wherein said motion sensor is a gyroscopic sensor.

11. The method of claim 10 further comprising:
calculating a displacement vector by employing a small angle approximation for a function that receives information indicative of angular displacement using said gyroscopic sensor.

12. The method of claim 8 wherein said motion sensor is an accelerometer.

13. The method of claim 12 wherein said accelerometer is disposed within said image capture device to provide a signal voltage proportional to an acceleration of said device along an axis within an image capture plane.

14. The method of claim 12 wherein a plurality of accelerometers generate said motion information, wherein said plurality of accelerometers provide at least one differential signal that is indicative of angular translation of said image capture device.

15. The method of claim 12 wherein a plurality of accelerometers are disposed within said image capture device in respective Cartesian planes.

16. A system, comprising:
means for generating video images;
means for detecting motion of said system; and
means for encoding said video images according to a motion compensation compression algorithm, wherein said means for encoding displaces search areas during motion vector calculation in response to information received from said means for detecting.

17. The system of claim 16 wherein said means for detecting comprises at least one accelerometer.

18. The system of claim 16 wherein said means for detecting generates at least one signal that is indicative of lateral translation of said system along an axis.

19. The system of claim 16 wherein said means for detecting generates at least one signal that is indicative of a change in angular orientation of said system.

20. The system of claim 16 wherein said means for encoding estimates an amount of pixel displacement between respective video frames in response to information received from said means for detecting.

21. A method, comprising:
generating video images by an imaging device;
detecting motion of said imaging device; and
encoding said video images according to a motion compensation compression algorithm, wherein said encoding displaces search areas during motion vector calculation in response to information received from said detecting.
